(19) United States
(12) Patent Application Publication
(10) Pub. No.: US 2013/0197935 A1
(43) Pub. Date: Aug. 1, 2013

(54) METHODS, APPARATUSES, AND COMPUTER PROGRAM PRODUCTS FOR IDENTIFYING CANDIDATES FOR A CLINICAL STUDY

(71) Applicants: Suzanne Obst, San Francisco, CA (US); Steve Hoffman, Scottsdale, AZ (US); Steven Angelides, Boston, MA (US); Diana Sifford, Phoenix, AZ (US)

(72) Inventors: Suzanne Obst, San Francisco, CA (US); Steve Hoffman, Scottsdale, AZ (US); Steven Angelides, Boston, MA (US); Diana Sifford, Phoenix, AZ (US)

(73) Assignee: MCKESSON CORPORATION, San Francisco, CA (US)

(21) Appl. No.: 13/362,647

(22) Filed: Jan. 31, 2012

(51) Int. Cl. G06Q 50/24

(52) U.S. Cl. 705/3

(57) ABSTRACT

Methods, apparatuses, and computer program products are provided for identifying candidates for a clinical study. A method may include determining a study criteria set specifying at least one criterion for qualification for the clinical study. The method may further include accessing electronic prescription transaction information. The method may additionally include identifying one or more prospective candidates for the clinical study at least in part by analyzing the electronic prescription transaction information to determine at least one patient having a prescription history satisfying the study criteria set. Corresponding apparatuses and computer program products are also provided.

### TECHNOLOGICAL FIELD

Embodiments of the present invention relate generally to medical technology and, more particularly, to methods, apparatuses, and computer program products for identifying candidates for a clinical study.

### BACKGROUND

Patient recruitment for clinical trials has been an ongoing challenge for pharmaceutical manufacturers and researchers. As escalation in drug development costs has continued to outpace sales growth and clinical research requirements have become more stringent and complex, qualified study subjects for clincial studies have become harder to identify and the need for new patient recruitment strategies has increased accordingly.

Most studies primarily rely upon a network of physician investigators to recruit study subjects from their existing patient bases. However, there is a shortage of investigators, and these investigators have limited patient populations, which often results in a significant patient shortfall. In order to attract additional patients, study sponsors may fund radio, television and print advertising or similar direct-to-consumer marketing strategies. However, these direct-to-consumer marketing campaigns are untargeted and expensive, and patient populations that can effectively be reached through this channel are becoming increasingly saturated. Sponsors may also use tactics such as social media, trial matching websites and services, as well as passive pharmacy outreach campaigns. However, these alternative approaches also have several drawbacks including a passive approach, high cost, and a lack of targeting, which yields inadequate volumes of eligible patients.

### BRIEF SUMMARY OF SOME EXAMPLES OF THE INVENTION

Methods, apparatuses, and computer program products are herein provided for identifying candidates for a clinical study. These methods, apparatuses, and computer program products may provide several advantages to patients, pharmaceutical companies sponsoring clinical studies, researchers, and pharmacies. In particular, some example embodiments provide for identifying candidates for a clinical study based at least in part on the candidates' electronic prescription transaction information. In this regard, some example embodiments provide for accessing electronic prescription transaction information that may be available from computerized pharmacy management systems, from data sent over a pharmacy transaction telecommunication network switch interfacing a pharmacy and a payor system, pharmacy benefit manager (PBM), and/or the like. Accordingly, such example embodiments may provide for the identification of patients having a prescription drug history indicating that they may qualify as candidates for a clinical study. The identified patients may be proactively targeted for participation in the clinical study. Accordingly, some example embodiments provide a relationship based identification and recruitment of candidates through the pharmacy channel. Such embodiments may yield a better pool of candidates for a clinical study than existing direct-to-consumer strategies that are not targeted to individuals having a medical history indicative that they may be qualified for the study. Some example embodiments further provide for identification of candidates based on electronic prescription transaction information in a manner compliant with patient privacy regulations.

In a first example embodiment, a method for identifying candidates for a clinical study is provided. The method of this example embodiment may comprise determining a study criteria set specifying at least one criterion for qualification for the clinical study. The method of this example embodiment may further comprise accessing electronic prescription transaction information. The method of this example embodiment may additionally comprise identifying one or more prospective candidates for the clinical study at least in part by analyzing the electronic prescription transaction information to determine at least one patient having prescription history satisfying the study criteria set.

In another example embodiment, an apparatus for identifying candidates for a clinical study is provided. The apparatus of this example embodiment comprises at least one processor. The at least one processor may be configured to cause the apparatus of this example embodiment to at least determine a study criteria set specifying at least one criterion for qualification for the clinical study. The at least one processor may be further configured to cause the apparatus of this example embodiment to access electronic prescription transaction information. The at least one processor may be additionally configured to cause the apparatus of this example embodiment to identify one or more prospective candidates for the clinical study at least in part by analyzing the electronic prescription transaction information to determine at least one patient having prescription history satisfying the study criteria set.

In a further example embodiment, a computer program product for identifying candidates for a clinical study is provided. The computer program product of this embodiment includes at least one non-transitory computer-readable storage medium having computer-readable program instructions stored therein. The program instructions of this example embodiment may comprise program instructions configured to determine a study criteria set specifying at least one criterion for qualification for the clinical study. The program instructions of this example embodiment may further comprise program instructions configured to access electronic prescription transaction information. The program instructions of this example embodiment may additionally comprise program instructions configured to identify one or more prospective candidates for the clinical study at least in part by analyzing the electronic prescription transaction information to determine at least one patient having a prescription history satisfying the study criteria set.

In yet another example embodiment, an apparatus for identifying candidates for a clinical study is provided. The apparatus of this example embodiment may comprise means for determining study criteria set specifying at least one criterion for qualification for the clinical study. The apparatus of this example embodiment may further comprise means for accessing electronic prescription transaction information. The apparatus of this example embodiment may additionally comprise means for identifying one or more prospective candidates for the clinical study at least in part by analyzing the electronic prescription transaction information to determine at least one patient having a prescription history satisfying the study criteria set.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates a system for identifying candidates for a clinical study according to some example embodiments;

FIG. 2 illustrates a block diagram of an apparatus for identifying candidates for a clinical study according to some example embodiments;

FIG. 3 illustrates a flow diagram according to an example process for identification and recruitment of candidates for a clinical study according to some example embodiments; and

FIG. 4 illustrates a flowchart according to an example method for identifying candidates for a clinical study according to some example embodiments.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, and/or the like.

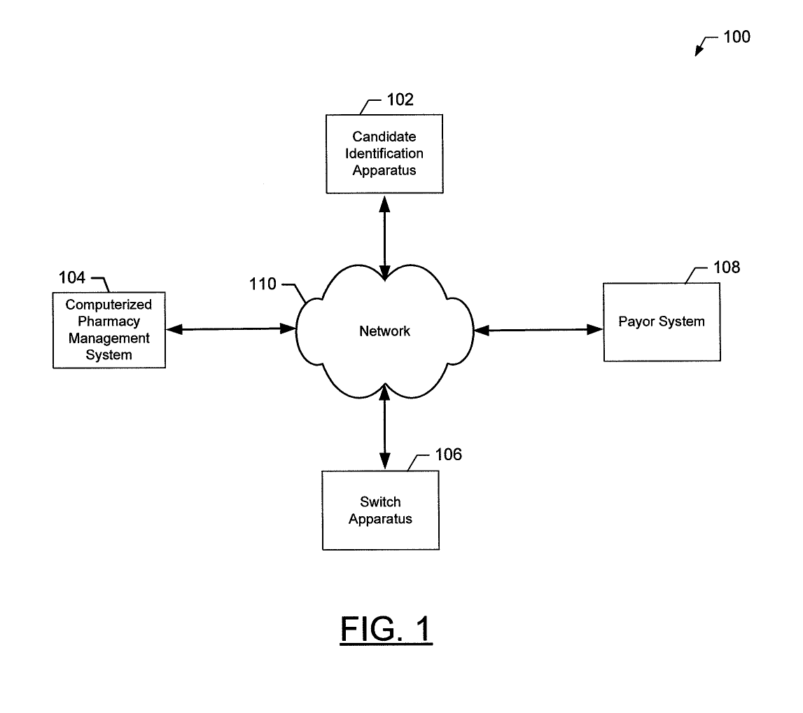

FIG. 1 illustrates a system 100 for identifying candidates for a clinical study according to some example embodiments. It will be appreciated that the system 100 as well as the illustrations in other figures are each provided as an example of some embodiments and should not be construed to narrow the scope or spirit of the disclosure in any way. In this regard, the scope of the disclosure encompasses many potential embodiments in addition to those illustrated and described herein. As such, while FIG. 1 illustrates one example of a configuration of system for identifying candidates for a clinical study, numerous other configurations may also be used to implement embodiments of the present invention.

It will be appreciated that the entities illustrated in FIG. 1 are illustrated by way of example, and not by way of limitation. As such, it will be appreciated that one or more of the entities illustrated in FIG. 1 may be optional, or even eliminated, in some example embodiments. Further, in some example embodiments, the system 100 may include one or more other entities in addition to or in lieu of the entities illustrated in FIG. 1.

In some example embodiments, the system 100 may comprise a candidate identification apparatus 102. The candidate identification apparatus 102 may be embodied as any computing device or combination of a plurality of computing devices configured to identify candidates for a clinical study in accordance with one or more example embodiments. In this regard, by way of non-limiting example, the candidate identification apparatus 102 may be embodied as one or more desktop computers, one or more laptop computers, one or more workstations, one or more network nodes, one or more servers, a server cluster, a cloud computing infrastructure, multiple computing devices in communication with each other, any combination thereof, and/or the like.

The candidate identification apparatus 102 may be configured to communicate with one or more further computing systems, such as, by way of example, one or more computerized pharmacy management systems 104, one or more pharmacy transaction telecommunication network switch apparatuses (also referred to as a “switch apparatus”) 106, one or more payor systems 108, and/or the like over a network 110. The network 110 may comprise one or more wireless networks (e.g., a cellular network, wireless local area network, wireless metropolitan area network, and/or the like), one or more wireline networks (e.g., a wired local area network, a wired wide area network, and/or the like), or some combination thereof, and in some embodiments comprises at least a portion of the internet. As such, while the network 110 is illustrated as a single network, it will be appreciated that the network 110 may comprise a combination of one or more public networks, one or more private networks, or a combination thereof. Further, it will be appreciated that one or more dedicated communications links may be used to connect two or more entities within the system 100 in addition to or in lieu of the network 110. For example, the pharmacy transaction telecommunication network switch apparatus 106 may form the basis of a dedicated communication link and/or network that may interconnect one or more computerized pharmacy management systems 104 with one or more payor systems 108. In embodiments wherein the network 110 comprises the internet, the system 100 may comprise a web-based system.

The computerized pharmacy management system 104 may comprise one or more computing devices that may be implemented at a pharmacy to form a computerized pharmacy management system. Additionally or alternatively, in some example embodiments, the computerized pharmacy management system 104 may comprise a cloud-based system which may be accessed from a plurality of pharmacy locations. The computerized pharmacy management system 104 may be configured to manage pharmacy workflow, maintain pharmacy inventory information, maintain a record of pharmacy transactions (e.g., a record of prescriptions filled by patients using the pharmacy), and/or the like. While only a single computerized pharmacy management system 104 is illustrated by way of example in FIG. 1, it will be appreciated that in some example embodiments, the system 100 may comprise a plurality of computerized pharmacy management systems 104. For example, each of a plurality of pharmacies may have its own computerized pharmacy management system 104, which may be configured to interface with the network 110.

The payor system 108 may be associated with a pharmacy benefit manager, an insurance company, a prescription transaction clearinghouse, or another third-party payor. The payor system 108 may comprise one or more computing devices which may be configured to receive, process, and fulfill payment requests from a computerized pharmacy management system 104 and/or switch apparatus 106 related to adjudication or benefits determination of pharmacy claims requests. In this regard, the payor system 108 may be configured to receive and process electronic prescription transaction information, such as electronic prescription claims information that may comprise claims data related to prescriptions filled by patients at a pharmacy. While only a single payor system 108 illustrated by way of example in FIG. 1, it will be appreciated that in some example embodiments, the system 100 may comprise a plurality of payor systems 108. For example, a plurality of insurance companies and/or other payors may each maintain their own payor system 108, which may be configured to interface with the network 110.

The pharmacy transaction telecommunication network switch apparatus 106 may comprise one or more computing devices that may be configured to route pharmacy transactions (e.g., electronic prescription transaction information) between one or more computerized pharmacy management systems 104 and one or more payor systems 108. By way of example, the pharmacy transaction telecommunication network switch apparatus 106 may comprise a McKesson® RelayHealth® switch.

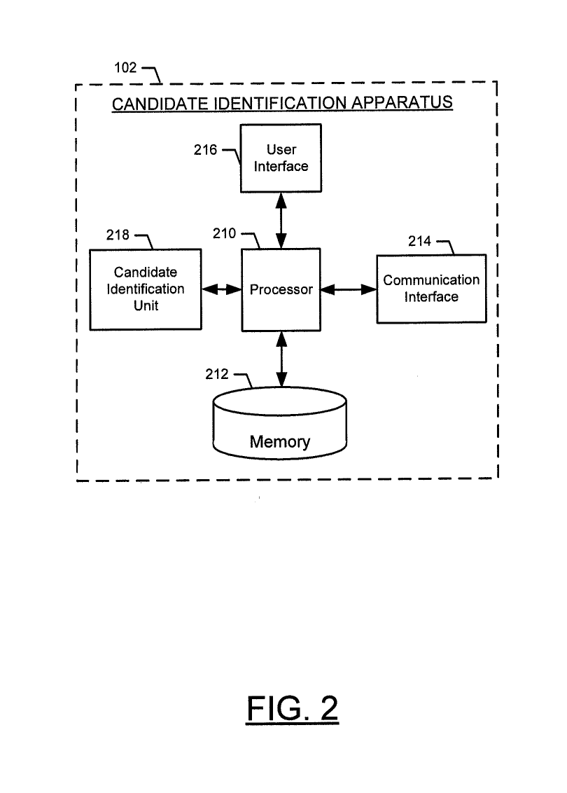

Referring now to FIG. 2, FIG. 2 illustrates a block diagram of a candidate identification apparatus 102 for identifying candidates for a clinical study according to some example embodiments. In some example embodiments the candidate identification apparatus 102 includes various means for performing the various functions described herein. These means may include, for example, one or more of a processor 210, memory 212, communication interface 214, user interface 216, or candidate identification unit 218 for performing the various functions herein described. The means of the candidate identification apparatus 102 as described herein may be embodied as, for example, circuitry, hardware elements (e.g., a suitably programmed processor, combinational logic circuit, and/or the like), a computer program product comprising a computer-readable medium (e.g. memory 212) storing computer-readable program instructions (e.g., software or firmware) that are executable by a suitably configured processing device (e.g., the processor 210), or some combination thereof.

The processor 210 may, for example, be embodied as various means including one or more microprocessors, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1 as a single processor, in some embodiments the processor 210 may comprise a plurality of processors. The plurality of processors may be embodied on a single computing device or may be distributed across a plurality of computing devices collectively configured to function as the candidate identification apparatus 102. The plurality of processors may be in operative communication with each other and may be collectively configured to perform one or more functionalities of the candidate identification apparatus 102 as described herein. In some embodiments, the processor 210 may be configured to execute instructions stored in the memory 212 or otherwise accessible to the processor 210. These instructions, when executed by the processor 210, may cause the candidate identification apparatus 102 to perform one or more of the functionalities of the candidate identification apparatus 102 as described herein. As such, whether configured by hardware or software methods, or by a combination thereof, the processor 210 may comprise an entity capable of performing operations according to embodiments of the present invention while configured accordingly. Thus, for example, when the processor 210 is embodied as an ASIC, FPGA or the like, the processor 210 may comprise specifically configured hardware for conducting one or more operations described herein. Alternatively, as another example, when the processor 210 is embodied as an executor of instructions, such as may be stored in the memory 212, the instructions may specifically configure the processor 210 to perform one or more algorithms and operations described herein.

The memory 212 may include, for example, volatile and/or non-volatile memory. Although illustrated in FIG. 1 as a single memory, the memory 212 may comprise a plurality of memories. The plurality of memories may be embodied on a single computing device or distributed across a plurality of computing devices. The memory 212 may comprise, for example, a hard disk, random access memory, cache memory, flash memory, an optical disc (e.g., a compact disc read only memory (CD-ROM), digital versatile disc read only memory (DVD-ROM), or the like), circuitry configured to store information, or some combination thereof. In this regard, the memory 212 may comprise any non-transitory computer readable storage medium. The memory 212 may be configured to store information, data, applications, instructions, and/or the like for enabling the candidate identification apparatus 102 to carry out various functions in accordance with example embodiments of the present invention. For example, in some example embodiments, the memory 212 is configured to buffer input data for processing by the processor 210. Additionally or alternatively, in some example embodiments, the memory 212 is configured to store program instructions for execution by the processor 210. The memory 212 may store information in the form of static and/or dynamic information. This stored information may be stored and/or used by the candidate identification unit 218 during the course of performing its functionalities.

In some example embodiments, the candidate identification apparatus 102 may include a communication interface(s), such as the communication interface 214. In embodiments including a communication interface, the communication interface 214 may be embodied as any device or means embodied in circuitry, hardware, a computer program product comprising a computer readable medium (e.g., the memory 212) storing computer readable program instructions executed by a processing device (e.g., the processor 210), or a combination thereof that is configured to receive and/or transmit data from/to another device with which the candidate identification apparatus 102 may be in communication. In some example embodiments, the communication interface 214 is at least partially embodied as or otherwise controlled by the processor 210. In this regard, the communication interface 214 may be in communication with the processor 210, such as via a bus. The communication interface 214 may additionally be in communication with the memory 212, user interface 216, and/or candidate identification unit 218, such as via a bus(es). The communication interface 214 may include, for example, an antenna, a transmitter, a receiver, a transceiver and/or supporting hardware or software for enabling communications with another computing device. The communication interface 214 may be configured to receive and/or transmit data using any protocol that may be used for communications between computing devices. As an example, the communication interface 214 may be configured to receive and/or transmit data using any protocol and/or communications technology that may be used for communicating over a network, such as the network 110. Accordingly, the communication interface 214 may provide means for receiving and/or transmitting data to/from one or more of a computerized pharmacy management system 104, pharmacy transaction telecommunication network switch apparatus 106, or payor system 108 over the network 110.

In some example embodiments, the candidate identification apparatus 102 may include a user interface, such as the user interface 216. The user interface 216 may be in communication with the processor 210 to receive an indication of a user input and/or to provide an audible, visual, mechanical, or other output to a user. As such, the user interface 216 may include, for example, a keyboard, a mouse, a joystick, a display, a touch screen display, a microphone, a speaker, and/or other input/output mechanisms. The user interface 216 may be in communication with the memory 212, communication interface 214, and/or candidate identification unit 218, such as via a bus(es).

The candidate identification unit 218 may be embodied as various means, such as circuitry, hardware, a computer program product comprising a computer readable medium (e.g., the memory 212) storing computer readable program instructions executed by a processing device (e.g., the processor 210), or some combination thereof and, in some example embodiments, is embodied as or otherwise controlled by the processor 210. In embodiments wherein the candidate identification unit 218 is embodied separately from the processor 210, the candidate identification unit 218 may be in communication with the processor 210. The candidate identification unit 218 may further be in communication with one or more of the memory 212, communication interface 214, or user interface 216, such as via a bus(es).

A clinical study may be sponsored by a research organization, a pharmaceutical or biotechnology manufacturer, and/or the like. The study sponsor, a party that may be contracted by the study sponsor (e.g., McKesson®) and/or other entity may use the candidate identification apparatus 102 to identify one or more candidates for a clinical study in accordance with some example embodiments.

The sponsor of the clinical study may define eligibility criteria for qualification for the study. The eligibility criteria may be related to patient medical history. In this regard, for example, the eligibility criteria for a study may require patients having a history of one or more diseases, medical conditions, ailments, and/or the like. For example, if the clinical study is for a drug to treat diabetes, eligibility criteria for the study may be patients having diabetes. As another example, eligibility criteria for a study may exclude patients having a history of one or more diseases, medical conditions, ailments, and/or the like. Thus, for example, patients having a history of hypertension may be excluded from a study.

Additionally or alternatively, eligibility criteria for a clinical study may include patient demographic information. For example, eligibility criteria may specify a desired age range, excluded age range, desired sex, desired/excluded patient location, and/or the like.

In some example embodiments, the candidate identification unit 218 may be configured to determine a study criteria set specifying at least one criterion for qualification for a clinical study. The study criteria set may, for example, be determined based at least in part on criteria that may be input by a user of the candidate identification apparatus 102, criteria that may be received and/or accessed from a third party source, such as via the network 110, and/or the like. The determined study criteria set may, for example, comprise study eligibility criteria that may be provided by the sponsor of the clinical study and/or may be derived based at least in part on the eligibility criteria for the study. Accordingly, the study criteria set may define medical conditions that may be required for qualification for the study, medical conditions that may exclude a patient from qualification for the study, required and/or excluded age ranges, a geographic location(s) in which candidates must/cannot reside, a required sex for qualification for the study, some combination thereof, or the like.

The candidate identification unit 218 may be further configured to access electronic prescription transaction information. The electronic prescription transaction information may, for example, comprise electronic prescription claims information (e.g., claims that may be filed with a payor system 108), records of prescription transactions that may be maintained by a pharmacy(ies), records of fees for prescription transactions, records of payment for prescription transactions, and/or the like. As a further example, the electronic prescription transaction information may additionally or alternatively comprise other prescription or drug related information or services provided by the pharmacy that may be communicated via the pharmacy transaction telecommunication network switch 106, such as medication therapy management (MTM) services and/or other non-prescription dispensing professional pharmacy services provided including pharmacist review of a patient's prescription history, pharmacist administered patient education services, drug adherence counseling services, and/or the like. By way of example, the accessed electronic prescription transaction information may comprise electronic prescription transaction information that may be sent to the candidate identification apparatus 102 and/or that may be stored in the memory 212. As another example, the candidate identification unit 218 may be configured to access electronic prescription claims information that may be sent from a computerized pharmacy management system 104 to a payor system 108 over the pharmacy transaction telecommunication switch apparatus 106. Accordingly, the candidate identification unit 218 may be configured in some example embodiments to interface with the pharmacy transaction telecommunication switch apparatus 106 to access electronic prescription claims information that may be sent over the switch apparatus. As a further example, the candidate identification unit 218 may be configured to access electronic prescription claims information that may be stored on and/or available from one or more computerized pharmacy management systems 104. As yet another example, the candidate identification unit 218 may be configured to access electronic prescription transaction information that may be stored on and/or available from one or more payor systems 108. The candidate identification unit 218 may accordingly be configured in some example embodiments to access electronic prescription transaction information at least in part by extracting electronic prescription transaction information from one or more data sources, such as a computerized pharmacy management system 104, payor system 108, and/or other source of prescription transaction information, such as may be accessible over the network 110. In some example embodiments wherein electronic prescription transaction information is sent to and/or accessed by the candidate identification apparatus 102, the electronic prescription transaction information may be securely transferred, such as via a secure File Transfer Protocol server.

The accessed electronic prescription transaction information may comprise a plurality of electronic prescription transactions, which may relate to prescriptions filled by patients that are customers of one or more pharmacies. As such, the individual electronic prescription transactions in the accessed electronic prescription claims information may each be associated with a respective patient. Accordingly, an electronic prescription transaction may specify a drug filled by the associated patient. An electronic prescription transaction may additionally be associated with a pharmacy that filled the patient's prescription.

Further, an electronic prescription transaction may be associated with patient demographic information, such as the patient's sex, age, location, contact information, and/or the like. In this regard, an electronic prescription transaction may include patient demographic information. Additionally or alternatively, the candidate identification unit 218 may be configured to determine the patient associated with an electronic prescription transaction and use the patient's identity to access patient demographic information, such as may be maintained locally on the candidate identification apparatus and/or on one or more remote systems, such as on a computerized pharmacy management system 104, payor system 108, and/or the like.

When accessing electronic prescription transaction information, the candidate identification unit 218 may be configured in some example embodiments to access electronic prescription transaction information selected based at least in part on the eligibility criteria for the study. For example, the candidate identification unit 218 may be configured to determine one or more pharmacies in the area (e.g., within a predefined distance) of the location(s) in which the study will be conducted and select to access electronic prescription transaction information originating from the determined pharmacies. Additionally or alternatively, the candidate identification unit 218 may be configured to select one or more pharmacies based at least in part on patient volume (e.g., pharmacies having at least a threshold number of patients), transaction volume (e.g., pharmacies having filled at least a threshold volume of prescriptions), and/or the like and to access electronic prescription transaction information originating from the selected pharmacies.

The candidate identification unit 218 may additionally be configured to analyze the accessed electronic prescription transaction information to determine one or more patients having a prescription history satisfying the study criteria set. Patients determined to have a prescription history satisfying the study criteria set may be identified as prospective candidates for the clinical study.

In some example embodiments, if the study criteria set specifies demographic criteria for qualification for the study, the candidate identification unit 218 may be configured to filter patients and/or electronic prescription transaction information based at least in part on the specified demographic criteria before and/or after determining patients having a prescription history satisfying the study criteria set. In this regard, patients having demographic qualities disqualifying them from the study may be eliminated from consideration as prospective candidates for the clinical study.

The candidate identification unit 218 may be configured in some example embodiments to translate the study criteria set into a drug identifier set. The drug identifier set may be comprised of one or more drug identifiers defining one or more drugs qualifying a patient for the clinical study, one or more drugs disqualifying the patient from the clinical study, and/or the like. The drug identifiers that comprise the drug identifier set may, for example, comprise National Drug Code (NDC) codes, Generic Classification Codes (GCN), and/or other similar pharmaceutical/therapeutic classification schema. However, it will be appreciated that the preceding examples of drug code classification schemes are provided by way of example, and not by way of limitation, as in various example embodiments, any type of drug code, identifier, and/or other drug identification nomenclature that may be used to classify and/or identify a drug that may be associated with an electronic prescription transaction may be used to form the drug identifier set. The candidate identification unit 218 may be further configured to analyze accessed prescription transaction information based at least in part on the drug identifier set to identify patients having a prescription history satisfying the study criteria set.

In order to translate the study criteria set into a drug identifier set, the candidate identification unit 218 may be configured to translate any diseases, medical conditions, ailments, and/or the like (collectively referred to as “conditions”) that a patient is required to have and/or that a patient must not have in order to qualify for participation in the study into one or more drug identifiers. In this regard, a condition may be mapped to a list of drugs used to treat the condition. Accordingly, the candidate identification unit 218 may be configured to translate certain medical condition(s) specified as criteria for the clinical study into a list of one or more drug identifiers for drugs having a predefined association with the conditions (e.g., drugs associated with treatment of the condition(s)).

Thus, for example, if a criterion for qualification for the clinical study is that a qualified patient must have diabetes, the condition may be translated into a set of drug identifiers for drugs associated with the treatment of diabetes. Accordingly, if a patient is determined to have filled a prescription for a drug associated with the treatment of diabetes based on the analysis of the accessed electronic prescription transaction information using drug identifiers for drugs associated with the treatment of diabetes, the patient may be considered as a prospective candidate for the clinical study provided the patient satisfies any other criteria for the study.

As another example, if a criterion for qualification for the clinical study is that a qualified patient does not have a history of hypertension, the condition may be translated into a set of drug identifiers for drugs associated with the treatment of hypertension. If a patient is determined to have obtained a prescription for a drug associated with the treatment of hypertension based on the analysis of the accessed electronic prescription transaction information using drug identifiers for drugs associated with the treatment of hypertension, the patient may be eliminated from further consideration as a prospective candidate for the clinical study.

In some example embodiments, patients identified as candidates for the clinical study may be invited to participate in a further screening process for the study. The invitation may be generated and/or otherwise initiated by, under the control of, and/or with the assistance of the candidate identification unit 218. For example, the invitation may comprise a letter, which may be generated (e.g., automatically, in response to a command from a user of the candidate identification apparatus 102, and/or the like) by the candidate identification unit 218. The invitation may introduce the clinical study program and invite the patient to contact a recruitment facilitator for further information and/or to opt out of receiving further communications relating to the study. As another example, the invitation may comprise an outbound call that may be placed to the prospective candidate. The outbound call may, for example, be initiated (e.g., automatically, in response to a command from a user of the candidate identification apparatus 102, and/or the like) by the candidate identification unit 218. In embodiments wherein an invitation letter is sent to a prospective candidate, the letter may be sent on behalf of the patient's pharmacist, and may provide contact information for the patient's pharmacy so that the patient may call or visit his or her pharmacy to discuss participation in the clinical study program. In some example embodiments, a patient identified as a candidate for the clinical study may be invited to participate in a further screening process for the study via multiple outreach efforts. For example, a letter may be sent to the patient, and the letter may be followed (e.g., after some period of time following the letter being sent to the patient) by an outbound call to the patient.

In some example embodiments, pharmacist verification of an identified prospective candidate may be obtained before an invitation is sent to the candidate. In this regard, a list of prospective candidates identified to be customers of a pharmacy may be generated and provided to the pharmacy for pharmacist verification. The candidate identification unit 218 may accordingly be configured in some example embodiments to group prospective candidates into pharmacy groups by their pharmacies and generate a prospective candidate list for each pharmacy group.

A prospective candidate list may be provided to a pharmacy by way of any appropriate transmission means. In some example embodiments, a prospective candidate list may be provided to a pharmacy in a manner compliant with any government-enforced privacy regulations that may govern usage and/or dissemination of protected health information (PHI), such as Health Insurance Portability and Accountability Act (HIPAA) and/or the like. By way of non-limiting example, a prospective candidate list may be provided to a pharmacy via any appropriate mode of sending the list to the pharmacy, including, for example, fax, email, mail, and/or the like. As a further example, a prospective candidate list may be accessed by a pharmacist from the candidate identification apparatus 102 over the network 110. In this regard, a portal (e.g., a secure portal) may be provided in some example embodiments so that pharmacists may access and verify prospective candidate lists online. In such embodiments, a pharmacy/pharmacist may be notified that a prospective candidate list is waiting for verification, such as by email. The notification may provide information for accessing the prospective candidate list, such as a URL at which the list may be viewed, password/login information for accessing the prospective candidate list, and/or the like.

A pharmacist may review the prospective candidate list and eliminate any prospective candidates that the pharmacist deems to be ineligible for participation in the study. In this regard, the pharmacist may know additional information about candidates beyond that which may be known and/or obtained by the candidate identification unit 218. The pharmacist may accordingly deem, based on that knowledge and the criteria for qualification for the study, that a prospective candidate is ineligible for participation. As another example, a pharmacist may have knowledge of extenuating circumstances that may make it difficult for a patient to participate in the study and may deem that patient ineligible to participate. As still a further example, a patient known by the pharmacist to be deceased may be deemed ineligible for participation in the study.

In embodiments wherein a prospective candidate list is faxed, emailed, or otherwise sent to the pharmacist, the pharmacist verification results may, for example, be returned by fax, email, mail, and/or the like. In embodiments in which a pharmacist verifies a prospective candidate list via an online portal or interface, the results may be provided to the candidate identification apparatus 102 through the pharmacist's online interaction with the candidate list. In an instance in which the pharmacist has deemed a prospective candidate to be ineligible to participate in the clinical study, the candidate may be eliminated from further consideration as a candidate for the clinical study prior to the candidate being sent an invitation to participate in further screening for the study.

In some example embodiments, the candidate identification unit 218 may be configured to track how many prospective candidates a respective pharmacist and/or pharmacy has reviewed. In some such example embodiments, a pharmacy and/or pharmacist may be compensated for reviewing prospective candidates. Accordingly, the candidate identification unit 218 may be configured to track an amount of compensation that may be due to a pharmacy and/or pharmacist for review of prospective candidates. The candidate identification unit 218 may be further configured to coordinate disbursement of compensation owed to a pharmacy and/or pharmacist.

In some example embodiments, if a candidate does not respond to an invitation to participate in a further screening process for the study within a pre-defined period of time, a follow-up communication to the candidate may be initiated. The follow-up may, for example, comprise initiation of an outbound call to the patient. The follow-up communication may, for example, be initiated by the candidate identification unit 218. For example, an automated call may be placed to the patient. As another example, the candidate identification unit 218 may prompt a user of the candidate identification apparatus 102 to follow-up with the candidate, such as by causing display of a notification on a display of the user interface 216, emailing an individual tasked with contacting the candidate, and/or the like. A candidate contacted with a follow-up may be provided with the option to opt out of further consideration for the clinical study, or in some instances to opt out from consideration for future studies.

If a candidate agrees to engage in further pre-screening, such as by calling a contact center in response to an invitation, the facilitator may provide further information about the clinical program and study. The facilitator may additionally determine the candidate's interest in the clinical study, and may provide the patient with an opportunity to opt out of the study and/or opt out of future studies.

If the candidate agrees to participate in a pre-screening assessment, a pre-screening assessment of the candidate may also be performed. In this regard, a facilitator may ask the candidate a series of pre-screening questions. In some example embodiments, the facilitator may be prompted to ask the pre-screening questions by the candidate identification unit 218, which may, for example, cause a series of predefined screening questions to be displayed to the facilitator via the user interface 216. As another example, a series of automated pre-recorded pre-screening questions may be played back to a candidate over the phone.

Candidate responses to the pre-screening questions may be obtained and a determination may be made as to whether the candidate satisfied the pre-screening assessment based on the candidate responses to the pre-screening questions. In some example embodiments, a human facilitator may document candidate responses to the pre-screening questions via the user interface 216. As another example, if automated pre-screening questions are read to the candidate, the patient may provide responses to the pre-screening questions via a touch tone phone, computing device, and/or other response means. The candidate identification unit 218 may be configured in some example embodiments to automatically determine whether the candidate satisfies the pre-screening assessment based on the patient responses. Alternatively, a human facilitator may manually determine whether the candidate satisfies the pre-screening assessment.

If a candidate satisfies the pre-screening assessment and consents to his or her personal contact information being forwarded to an investigator that is responsible for enrolling patients in the clinical study, the candidate's personal contact information may be sent to the investigator, such as via email, fax, posting to a web interface (e.g., a secure web interface), and/or the like. In some example embodiments, candidate contact information and/or other candidate information that may be forwarded to an investigator may be forwarded to the investigator in a manner compliant with any government-enforced privacy regulations that may govern usage and/or dissemination of patient information, such as HIPAA and/or the like. The investigator may be responsible for final clearance and enrollment of the candidate in the clinical study.

As another example, in some embodiments, if a candidate satisfies the pre-screening assessment and does not wish to opt out of participation in the study, the candidate may be provided with information to contact an investigator that may be responsible for enrolling patients in the clinical study in addition to or in lieu of the candidate's contact information being forwarded to the investigator. The candidate may accordingly use the contact information to directly contact the investigator. In some such example embodiments, if the candidate does not contact the investigator within a predefined period of time following being referred to the investigator, a follow-up communication to the candidate may be initiated. The follow-up may, for example, comprise initiation of an outbound call to the candidate. The follow-up communication may, for example, be initiated by the candidate identification unit 218. For example, an automated call may be placed to the candidate. As another example, the candidate identification unit 218 may prompt a user of the candidate identification apparatus 102 to follow-up with the candidate, such as by causing display of a notification on a display of the user interface 216, emailing an individual tasked with contacting the candidate, and/or the like.

As still a further example, in some example embodiments, an online portal may be provided to enable a patient to self-enroll in the study provided that the candidate has satisfied the pre-screening assessment. In this regard, some studies may not employ a human investigator responsible for enrolling a candidate in the study and/or an automated portal may be provided for candidates having computer access to reduce burden on a human investigator. The candidate identification unit 218 may be configured in such example embodiments to provide an online portal that may be accessed over a network, such as the network 110, by a user of a network-connected computing device. The online portal may enable a candidate to provide informed consent and enroll in the study. In some example embodiments, the online portal may be secured, such as by password protection, so that a candidate that has not satisfied the pre-screening assessment may not log onto the portal to enroll in the study. In this regard, in embodiments wherein the portal is secured, a candidate that has satisfied the pre-screening assessment may, for example, be provided with a password and/or other security credential to enable the candidate to log onto the portal. In some example embodiments, an online portal may be provided in studies in which a patient enrolled in the study may self-report results. In this regard, a patient enrolled in a study in such example embodiments may log onto the portal and report results and/or other data that may be monitored as part of the study.

In some example embodiments, identification of prospective candidates for a clinical study may be performed under authorization of a waiver that may be obtained from an Institutional Review Board or other body empowered with granting a waiver. The waiver may, for example, authorize at least a partial waiver from government-enforced privacy regulations, such as HIPAA regulations. In conjunction with authorizing a waiver, the Institutional Review Board may, for example, review parameters of the clinical study, review invitation letters to be sent to a candidate, review pre-screening questions, and/or the like, and may grant or deny a waiver based on this review.

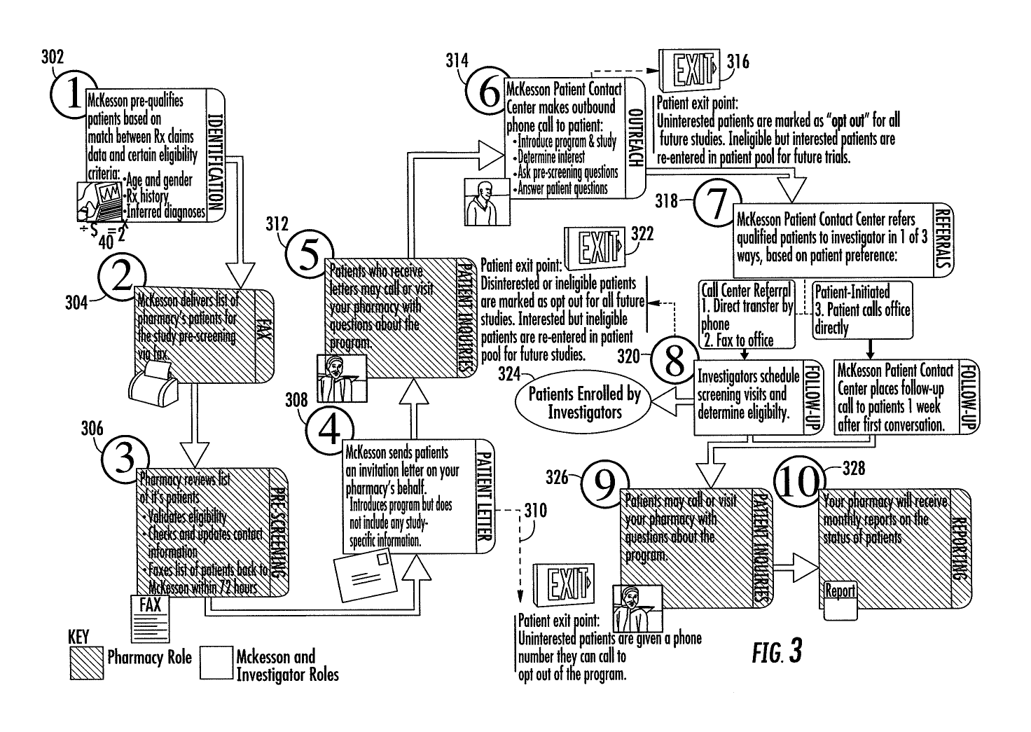

Referring now to FIG. 3, FIG. 3 illustrates a flow diagram according to an example process for identification and recruitment of candidates for a clinical study according to some example embodiments. The process may be performed with the assistance of an entity, such as McKesson®, that may be contracted to identify candidates for a clinical study. The contractor may be responsible for operation of the candidate identification apparatus 102 and/or may otherwise utilize the candidate identification apparatus 102 to facilitate identification of candidates for the study. Accordingly, operations illustrated and described in FIG. 3 to be performed by McKesson may be performed by, with the assistance of, and/or under the control of the candidate identification apparatus 102.

Operation 302 may comprise McKesson pre-qualifying candidates based at least in part on a match between electronic prescription transaction information, such as electronic prescription claims information, and a study criteria set specifying criteria for qualification for the study. The study criteria set may comprise medical condition history requirements, prescription history requirements, age requirements, gender requirements, and/or the like. The pre-qualification of a patient candidate may be based on inferred diagnoses that may be drawn based on the patient's prescription history. In this regard, if the patient has a prescription history associated with one or more medications known to be associated with treatment of a particular condition, an inferred diagnosis may be made that the patient has that particular condition. If a patient is determined to be pre-qualified for the study, the patient may be identified as a prospective candidate for the study.

Operation 304 may comprise generating and delivering a prospective candidate list of patients of a pharmacy that are identified as prospective candidates to the pharmacy for pharmacist verification and pre-screening. The list may, for example, be faxed to the pharmacy. However, it may be appreciated that the list may be delivered to the pharmacy by other methods, such as by email, an online portal, mail, and/or the like.

Operation 306 may comprise the pharmacy (e.g., a pharmacist and/or other responsible pharmacy personnel) performing a pharmacy verification of the prospective candidate list. The pharmacy may validate eligibility of listed candidates, and may remove any candidates deemed to be ineligible. The pharmacy may additionally verify and update contact information for the listed candidates. In some instances, the pharmacy may be requested to return the verified list to McKesson within a predefined period of time, such as 72 hours. However, it will be appreciated that return of the verified list within 72 hours is illustrated by way of example, and not by way of limitation. The pharmacy may, for example, return the verified list by way of fax. However, it will be appreciated that other communication means may be used to return the verified list, such as, for example, email, an online interface, and/or the like.

Operation 308 may comprise McKesson generating and sending an invitation letter to prospective candidates. The invitation letter may, for example, be sent on behalf of a candidate's pharmacy. The invitation letter may introduce the program. However, in some instances, the letter may not include study specific information. The letter may provide contact information, such as phone number, which the candidate may use to opt out of the study, opt out of the clinical study recruitment program, and/or agree to participate in further screening for the study.

If a candidate decides to opt out of the study, the candidate may use the contact information provided in the invitation letter to opt out, as illustrated by operation 310. If the candidate opts out, he or she is eliminated from further consideration as a candidate for the study. If a candidate has questions about the clinical study recruitment program after receiving the invitation letter, the candidate may optionally call or visit his or her pharmacy with those questions, as illustrated in operation 312.

Operation 314 may comprise McKesson contacting a prospective candidate. In some embodiments, this contact may be candidate initiated, such as in response to the invitation letter. Alternatively, the contact may be initiated by McKesson, which may place an outbound call to the candidate. The outbound call may, for example, be placed to the candidate a predefined period of time (e.g., 7 days) after the invitation letter is sent to the patient provided that the candidate has not already contacted McKesson to opt out of the clinical study recruitment program or to initiate further screening for the study.

During the call, a facilitator may validate the candidate's identification and introduce the patient recruitment program and clinical study. The facilitator may determine the candidate's interest in further participation in the recruitment program and clinical study. If the candidate is uninterested, the candidate may be presented with an opportunity to opt out of further consideration for the clinical study and/or future studies, as indicated by operation 316. If the candidate decides to opt out, the candidate may be eliminated from further consideration.

If the candidate is interested in continuing to participate in the patient recruitment program and, provided that the candidate is eligible for the clinical study, the facilitator may ask a series of pre-screening questions as part of a pre-screening assessment, and may document the candidate's responses to the questions. If the candidate does not satisfy the pre-screening assessment, the candidate may be deemed ineligible for participation in the clinical study. An ineligible candidate may be re-entered in a patient pool for future clinical trials, as indicated by operation 316.

If, however, the candidate satisfies the pre-screening assessment, the candidate may be referred to an investigator that is responsible for enrolling patients in the clinical study, as indicated by operation 318. In some example embodiments, the candidate may only be referred to the investigator if the candidate first provides al consent (e.g., a lawful consent) to be referred to the investigator. The candidate may be referred to the investigator by way of any of several methods. The method by which a candidate is referred to the investigator may, for example, vary by embodiment and/or based on candidate preference/consent. In some example embodiments, a candidate satisfying a pre-screening assessment may additionally be sent (e.g., via mail, email, fax, and/or the like) information about the study, which the candidate may review (e.g., independently, with a family member, with a primary care physician, and/or other trusted advisor).

Referral of a candidate to the investigator may comprise direct referral to the investigator by the McKesson call center. In this regard, the facilitator performing the pre-screening may transfer the candidate by phone to the investigator. Additionally or alternatively, McKesson may send the candidate's contact information to the investigator, such as by fax, email, and/or the like. Alternatively, referral of a candidate to the investigator may comprise candidate-initiated referral, in which the candidate may be responsible for initiating contact with the investigator. In this regard, the candidate may be provided with a phone number and/or other contact information with the investigator. If the candidate fails to contact the investigator by a predefined period of time following the pre-screening assessment (e.g., 1 week), the McKesson Patient Contact Center may place a follow-up call to the candidate to remind the candidate to contact the investigator.

The investigator may schedule a screening appointment with the candidate in order to make a final determination of the candidate's eligibility for participation in the study, as indicated by operation 320. The screening appointment may comprise an in-person visit with the candidate. If the investigator deems the candidate to be ineligible for the study, the candidate may be eliminated from further consideration for the study, as indicated by operation 322. The investigator may additionally give the candidate another opportunity to opt out of further consideration for the current study and/or future studies. If the candidate decides to opt out of the current study but to remain in consideration for future studies, the candidate may be re-entered in a patient pool for future studies, as indicated by operation 322. If, however, the candidate decides to opt out of participation in the patient recruitment program for both the current study and all future studies, the candidate may be removed from the patient pool and eliminated from further consideration for both the current and future studies.

If the investigator deems the candidate to be eligible for the study and the candidate consents to participation in the study, the candidate may be enrolled by the investigator for participation in the study, as illustrated by operation 324.

If a patient enrolled in the study has any questions about the clinical study or recruitment program, the patient may optionally visit or call his or her pharmacy, as illustrated by operation 326. In some example embodiments, a pharmacy may be provided with a periodic (e.g., weekly, monthly, or the like) status report of its patients participating in the clinical study, as illustrated in operation 328.

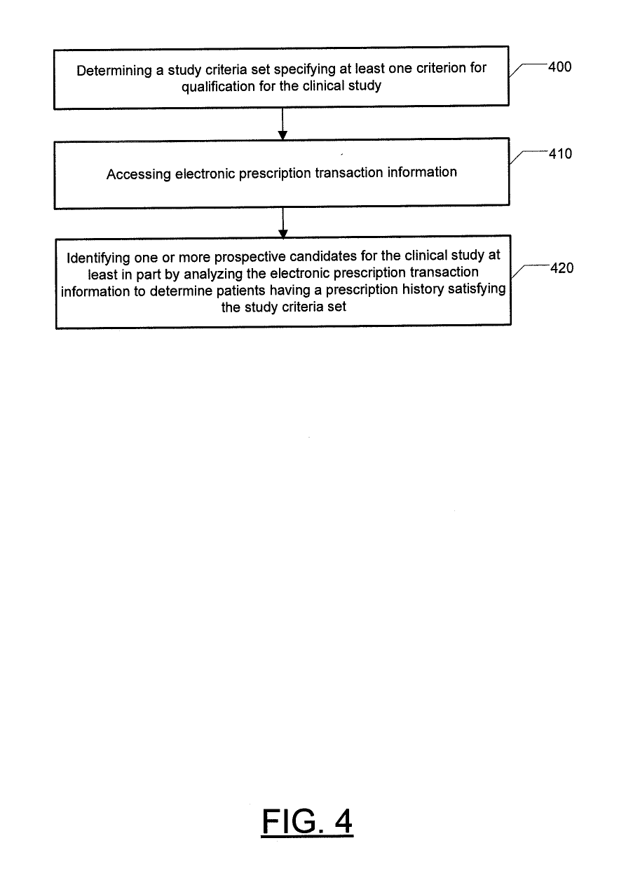

Referring now to FIG. 4, FIG. 4 illustrates a flowchart according to an example method for identifying candidates for a clinical study according to some example embodiments. In this regard, FIG. 4 illustrates a method that may be at least partially performed by a candidate identification apparatus 102. The operations illustrated in and described with respect to FIG. 4 may, for example, be performed by, with the assistance of, and/or under the control of one or more of the processor 210, memory 212, communication interface 214, user interface 216, or candidate identification unit 218. Operation 400 may comprise determining a study criteria set specifying at least one criterion for qualification for the clinical study. The processor 210, memory 212, communication interface 214, user interface 216, and/or candidate identification unit 218 may, for example, provide means for performing operation 400. Operation 410 may comprise accessing electronic prescription transaction information. The processor 210, memory 212, communication interface 214, user interface 216, and/or candidate identification unit 218 may, for example, provide means for performing operation 410. Operation 420 may comprise identifying one or more prospective candidates for the clinical study at least in part by analyzing the electronic prescription transaction information to determine patients having a prescription history satisfying the study criteria set. The processor 210, memory 212, communication interface 214, user interface 216, and/or candidate identification unit 218 may, for example, provide means for performing operation 420.

FIG. 4 illustrates a flowchart of a system, method, and computer program product according to example embodiments of the invention. It will be understood that each block of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a server, desktop computer, laptop computer, mobile computer, or other computing device (e.g., an candidate identification apparatus 102) and executed by a processor (e.g., the processor 210) in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks or steps of the flowchart support combinations of means for performing the specified functions and combinations of steps for performing the specified functions. It will also be understood that one or more blocks of the flowchart, and combinations of blocks in the flowchart, may be implemented by special purpose hardware-based computer systems which perform the specified functions or steps, or combinations of special purpose hardware and computer program product(s).

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for identifying candidates for a clinical study, the method comprising:
determining a study criteria set specifying at least one criterion for qualification for the clinical study;
accessing electronic prescription transaction information; and
identifying one or more prospective candidates for the clinical study at least in part by analyzing, by a processor, the electronic prescription transaction information to determine at least one patient having a prescription history satisfying the study criteria set.

2. The method of claim 1, further comprising:
translating the study criteria set into a drug identifier set comprised of one or more drug identifiers defining one or more of one or more drugs qualifying a patient for the clinical study or one or more drugs disqualifying the patient from the clinical study; and
wherein analyzing the electronic prescription transaction information comprises analyzing the prescription transaction information based at least in part on the drug identifier set to determine at least one patient having a prescription transaction history satisfying the study criteria set.

3. The method of claim 2, wherein translating the study criteria set into the drug identifier set comprises:
determining one or more patient conditions associated with the study criteria set; and
determining one or more drug identifiers having a predefined association with the determined one or more patient conditions.

4. The method of claim 1, further comprising:
determining a pharmacy used by each of the one or more prospective candidates;
grouping the prospective candidates into at least one pharmacy group, wherein each pharmacy group is associated with a respective pharmacy and has a membership including any prospective candidates determined to use the pharmacy associated with the pharmacy group; and
for a first pharmacy group of the at least one pharmacy group:
generating a prospective candidate list for the first pharmacy group for sending to the pharmacy associated with the first pharmacy group for pharmacist verification, wherein the prospective candidate list is comprised of the membership of the first pharmacy group; and
in an instance in which a prospective candidate on the prospective candidate list is deemed ineligible to participate in the clinical study based at least in part on the pharmacist verification, eliminating the ineligible candidate from further consideration as a candidate for the clinical study prior to contacting the ineligible candidate.

5. The method of claim 1, further comprising:
generating an invitation inviting an identified prospective candidate to participate in a screening process for the clinical study.

6. The method of claim 5, further comprising, in an instance in which the invited prospective candidate does not respond to the invitation within a predefined period of time, causing initiation of an outbound call to the invited prospective candidate.

7. The method of claim 5, further comprising, in an instance in which a call is received from the invited prospective candidate in response to the invitation:
performing a pre-screening assessment of the invited prospective candidate; and
in an instance in which the invited prospective candidate satisfies the pre-screening assessment and consents to personal contact information being forwarded to an investigator associated with the clinical study, causing the personal contact information for the invited prospective candidate to be sent to the investigator associated with the clinical study.

8. The method of claim 1, wherein accessing electronic prescription transaction information comprises accessing electronic prescription transaction information sent over a pharmacy transaction telecommunication network switch interfacing one or more pharmacies with a payor system.

9. The method of claim 1, wherein identifying one or more prospective candidates for the clinical study comprises identifying one or more prospective candidates under authorization of a waiver received from an Institutional Review Board.

10. An apparatus for identifying candidates for a clinical study, the apparatus comprising at least one processor, wherein the at least one processor is configured to cause the apparatus to at least:
determine a study criteria set specifying at least one criterion for qualification for the clinical study;
access electronic prescription transaction information; and
identify one or more prospective candidates for the clinical study at least in part by analyzing the electronic prescription transaction information to determine at least one patient having prescription history satisfying the study criteria set.

11. The apparatus of claim 10, wherein the at least one processor is further configured to cause the apparatus to:
translate the study criteria set into a drug identifier set comprised of one or more drug identifiers defining one or more of one or more drugs qualifying a patient for the clinical study or one or more drugs disqualifying the patient from the clinical study; and
identify the one or more prospective candidates at least in part by analyzing the prescription transaction information based at least in part on the drug identifier set to determine at least one patient having a prescription transaction history satisfying the study criteria set.

12. The apparatus of claim 11, wherein the at least one processor is further configured to cause the apparatus to translate the study criteria set into the drug identifier set at least in part by:
determining one or more patient conditions associated with the study criteria set; and
determining one or more drug identifiers having a predefined association with the determined one or more patient conditions.

13. The apparatus of claim 10, wherein the at least one processor is further configured to cause the apparatus to:
determine a pharmacy used by each of the one or more prospective candidates;
group the prospective candidates into at least one pharmacy group, wherein each pharmacy group is associated with a respective pharmacy and has a membership including any prospective candidates determined to use the pharmacy associated with the pharmacy group; and
for a first pharmacy group of the at least one pharmacy group:
generate a prospective candidate list for the first pharmacy group for sending to the pharmacy associated with the first pharmacy group for pharmacist verification, wherein the prospective candidate list is comprised of the membership of the first pharmacy group; and
in an instance in which a prospective candidate on the prospective candidate list is deemed ineligible to participate in the clinical study based at least in part on the pharmacist verification, eliminate the ineligible candidate from further consideration as a candidate for the clinical study prior to contacting the ineligible candidate.

14. The apparatus of claim 10, wherein the at least one processor is further configured to cause the apparatus to:
generate an invitation inviting an identified prospective candidate to participate in a screening process for the clinical study.

15. The apparatus of claim 14, wherein the at least one processor is further configured to cause the apparatus, in an instance in which the invited prospective candidate does not respond to the invitation within a predefined period of time, cause initiation of an outbound call to the invited prospective candidate.

16. The apparatus of claim 14, wherein the at least one processor is further configured to cause the apparatus, in an instance in which a call is received from the invited prospective candidate in response to the invitation, to:
perform a pre-screening assessment of the invited prospective candidate; and
in an instance in which the invited prospective candidate satisfies the pre-screening assessment and consents to personal contact information being forwarded to an investigator associated with the clinical study, cause the personal contact information for the invited prospective candidate to be sent to the investigator associated with the clinical study.

17. The apparatus of claim 10, wherein the at least one processor is further configured to cause the apparatus to access the electronic prescription transaction information at least in part by accessing electronic prescription transaction information sent over a pharmacy transaction telecommunication network switch interfacing one or more pharmacies with a payor system.

18. The apparatus of claim 10, wherein the apparatus is implemented on a web-based system comprising at least one computerized pharmacy management system and a payor system.

19. The apparatus of claim 10, further comprising at least one memory storing instructions, which when performed by the at least one processor configure the at least one processor to cause the apparatus to at least:
determine the study criteria set;
access electronic prescription transaction information; and
identify one or more prospective candidates for the clinical study at least in part by analyzing the electronic prescription transaction information to determine at least one patient having a prescription history satisfying the study criteria set.

20. A computer program product for identifying candidates for a clinical study, the computer program product comprising at least one non-transitory computer-readable storage medium having computer-readable program instructions stored therein, the computer-readable program instructions comprising:
program instructions configured to determine a study criteria set specifying at least one criterion for qualification for the clinical study;
program instructions configured to access electronic prescription transaction information; and
program instructions configured to identify one or more prospective candidates for the clinical study at least in part by analyzing the electronic prescription transaction information to determine at least one patient having a prescription history satisfying the study criteria set.
